(19) United States
(12) Patent Application Publication
(10) Pub. No.: US 2009/0073178 A1
(43) Pub. Date: Mar. 19, 2009

(54) COMPRESSING SCHEME USING QUALIFIER WATERMARKING AND APPARATUS USING THE COMPRESSION SCHEME FOR TEMPORARILY STORING IMAGE DATA IN A FRAME MEMORY

(75) Inventor: Matheus J. G. Lammers, Nederweert (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/293,269

(22) PCT Filed: Mar. 14, 2007
(86) PCT No.: PCT/IB07/50865

§ 371 Date: Sep. 16, 2008

(30) Foreign Application Priority Data
Mar. 17, 2006 (EP) 06111329.6

(51) Int. Cl. G09G 5/36; G06K 9/46

(52) U.S. Cl. 345/549; 382/237

(57) ABSTRACT

Display driver (10) with a frame memory (13) for temporarily storing image data representing a color image, and a data bus (11.1) for feeding image data to the display driver (10). The display driver (10) comprises means for performing a decision process (8, 9), said decision process being based on an analysis of the color characteristics of a pixel cluster of said image data, the means for performing a decision process (8, 9) allowing the display driver (10) to decide whether a first compression format or a second compression format is to be applied for compression of said pixel cluster. It further comprises first compression means (7) performing a compression of said pixel cluster into said first compression format, and second compression means (6) performing a compression of said pixel cluster into said second format. The first compression format or second compression format is selected based upon the results of the decision process so that the compressed pixel clusters can be stored after compression in an available storage area of the frame memory (13). A compression-format code is stored indicating which compression format was used for which pixel cluster. This compression-format code is embedded into the compressed pixel clusters as a watermark.

The present invention concerns a novel compression scheme and in particular an implementation of the novel compression scheme in a display driver with a frame memory for temporarily storing image data representing a color image.

There are many applications where image compression is performed. In image compression, several compression methods are available. The properties of natural scenes are used by compression algorithms in such a way that the introduced quality loss is acceptable for a human viewer. A method that provides satisfactory results for natural images (images with limited color fluctuation between adjacent pixels) performs bad on non-natural image types (e.g. data-graphics, text) and vice versa.

Natural images are often compressed by first converting them to the YUV domain, using a luminance and two chroma (color) components. An example of such a format is called YUV 4:4:4. As the eye is typically less sensitive to color changes over small distances, the chroma components can be shared between two adjacent pixels. This format is called YUV 4:2:2 and gives a 33% reduction of the required storage area or bus bandwidth with only a small reduction of the perceived image quality for natural scenes. When the chroma components are shared of four adjacent pixels (e.g. YUV 4:2:0) a reduction of 50% is possible. The problem with YUV 4:2:2 and YUV 4:2:0 compression is that for non-natural image types (e.g. data-graphics, text), additional artifacts are introduced that are easily visible. This is because non-natural images are not limited in bandwidth (Nyquist sampling theorem does not apply) and sharp changes in color between adjacent pixels may occur, causing visible wrong colors after compression.

For the storage of images, there are many methods of compression, which can typically be split in three types, as follows:

(1) Lossless compression (e.g., GIF, TIFF, RLE): the problem with this format is that it does not provide a fixed compression factor. Such a format cannot be used for the compression of images to be stored in the frame memory of a display driver, since the frame memory would need to be increased in size in order to be able to store all possible images.
(2) Lossy compression (e.g., JPG, MPEG): these typically use color-space conversion (YUV domain), and then frequency (DCT) conversion of the image before eliminating some information and then losslessly compressing the result. This technique requires significant processing and also a buffer memory during the conversion. This approach is not useable for compression in a frame memory because the amount of added hardware to the display driver, for example, must be minimal.
(3) Limited compression ratios (e.g., YUV): Images are often stored in YUV format, allowing for individual processing of luminance and chroma information. The analog TV transmission standards also use the YUV domain where the bandwidth used for luminance transmission is significantly higher than that used for the chroma channels. The same method is usable for reduced frame memory storage, although extensive artifacts are introduced for non-natural images.

There are various examples of smart compression methods where the compression algorithm is designed in order to avoid artifacts or the like.

A guaranteed compression can not be achieved with the known smart compression methods if one wants at the same time to obtain a color image of high quality.

Memory is a precious resource in many applications. In particular in mobile applications there usually are certain constraints as to the size of the available memory. Many mobile devices nowadays are equipped with a display. The amount of frame memory needed in the display driver of such a display significantly adds to the cost of the overall device.

Thus, it would be generally desirable to provide a compression scheme for use in a frame memory of a display driver that is able to handle all types of images. Furthermore, this compression scheme should allow the size of the frame memory to be reduced. This, however, can only be achieved if a certain minimum compression ratio can be ensured (guaranteed compression ratio) independent of the type of image.

A well suited compression scheme was proposed in European Patent Application No. 05101512.1, currently assigned to the assignee of the present application. As illustrated in this co-pending patent application, the required storage capacity of an image can be reduced with a color compression technique based on YUV 4:2:2, by a theoretical maximum of 67%. With YUV 4:2:2 filtering, two adjacent pixels (pixel pair) share the same color. With natural images this will give no visible artifacts, but mobile display drivers typically have to deal also with artificially generated data graphical images. Since in such situations it is not allowed to filter steep color edges in data graphics, a fallback scenario was applied that encodes these edges as so-called quantized pixels. This approach, however, requires a qualifier signal to be introduced since the decompression logic has to be able to distinguish between YUV 4:2:2-based compression and the quantized compression.

If image data were stored in the YUV format directly, then a bit resolution problem is present. The YUV matrix operation applied when encoding image data before storing them in the frame memory leads to a rotation and scaling of the RGB pixel vector which now becomes expressed in the orthogonal YUV system. Thus additional memory bits are required in order to represent the YUV components and hence the compression factor will be reduced again. The above-mentioned co-pending patent application thus proposes an alternative storage format referred to as RGBG. This storage format does not require these additional memory bits. Using the RGBG format, the theoretical compression format of 67% can be achieved if the qualifier is hidden in the image data.

It is thus an object of the present invention to provide a compression scheme allowing the size of the frame memory to be further reduced.

It is a further objective of the present invention to provide a compression scheme that allows a low cost implementation in a frame memory of a display driver.

It is a further objective of the present invention to improve conventional display drivers.

These disadvantages of known systems, as described above, are reduced or removed with the invention as described and claimed herein.

An apparatus in accordance with the present invention is claimed in claim 1. Various advantageous embodiments are claimed in claims 2 through 11.

According to the present invention, two compression formats are used to compress an image. An analysis is made of the color characteristics of at least two neighboring pixels, herein referred to as pixel cluster, before the image is compressed and stored. The outcome of this analysis leads to the choice for the better compression method for the respective pixel cluster and the data of the respective pixel cluster are compressed using the better compression method. Furthermore, a so-called qualifier (compression-format code) is required indicating which of the compression methods has been used for compressing the image data of the pixel cluster. The compression-format code is required by the decompression process when reading the pixel data from the frame memory for presentation of the color image on the display panel. The qualifier is embedded into the compressed and stored data as a watermark, that is in such as way that it does not lead to noticeable image artifacts after decompression.

By intelligently selecting when to store a pixel cluster in the image in YUV 4:2:2 format and when to store it in a quantized RGB format and by storing the corresponding qualifier as watermark, the present invention allows to further reduce the size of the frame memory in comparison to known approaches. The selection is done according to the present invention by considering the respective errors of each of the two compression schemes. Preferably the compression results are compared with the original input and the result closest to the original is chosen for storage.

The method described and claimed will not introduce visible artifacts for non-natural images.

Methods in accordance with the present invention are claimed in the independent claim 12. Various advantageous embodiments are claimed in claims 13 through 16.

The inventive compression method has the advantage that it handles different image types in a satisfactory way.

The compression scheme(s) according to the present invention can be used for on-the-fly compression of image data when transferring them to the frame memory of a display driver.

According to the present invention, when compressed image data is read from the frame memory, an inverse operation (on-the-fly decompression) is employed before delivering the “re-constructed” image data via some additional circuitry, such as a frame rate converter and a digital-to-analog converter, to a display panel.

The present invention allows the qualifier to be stored together, i.e. inside, the compressed data without significant processing, power or cost impact.

A further advantageous property of the invention is that it does not require much processing. The present invention can thus be implemented in mobile devices, for instance.

Additional features and advantages of the invention will be set forth in the description that follows, and in part will be apparent from the description.

For a more complete description of the present invention and for further objects and advantages thereof, reference is made to the following description, taken in conjunction with the accompanying drawings, in which:

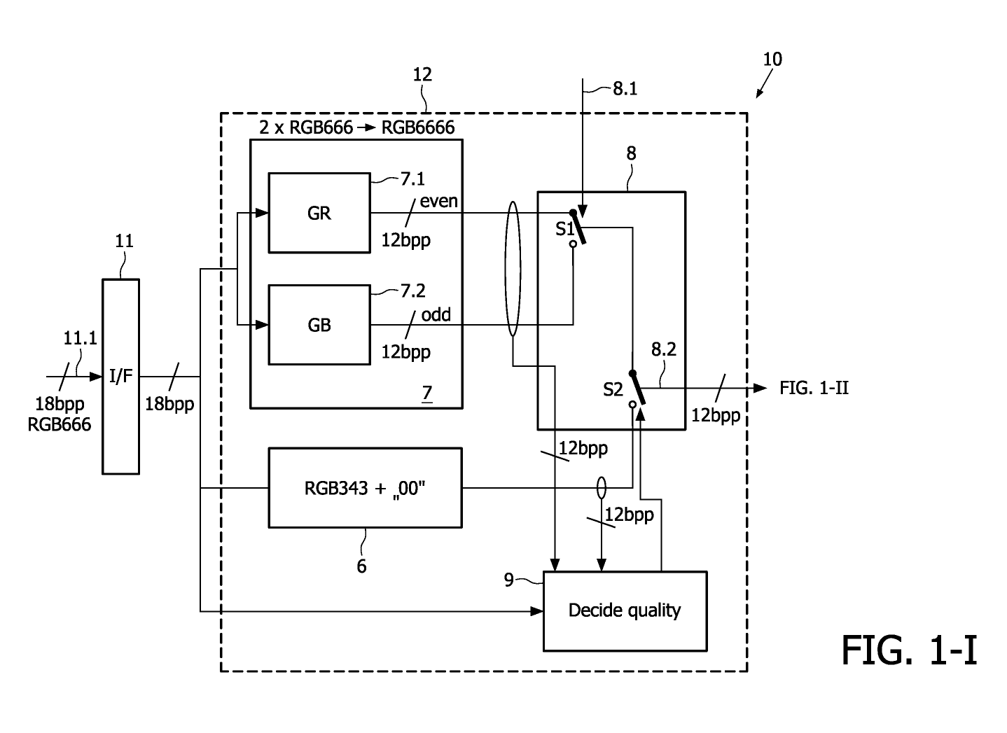

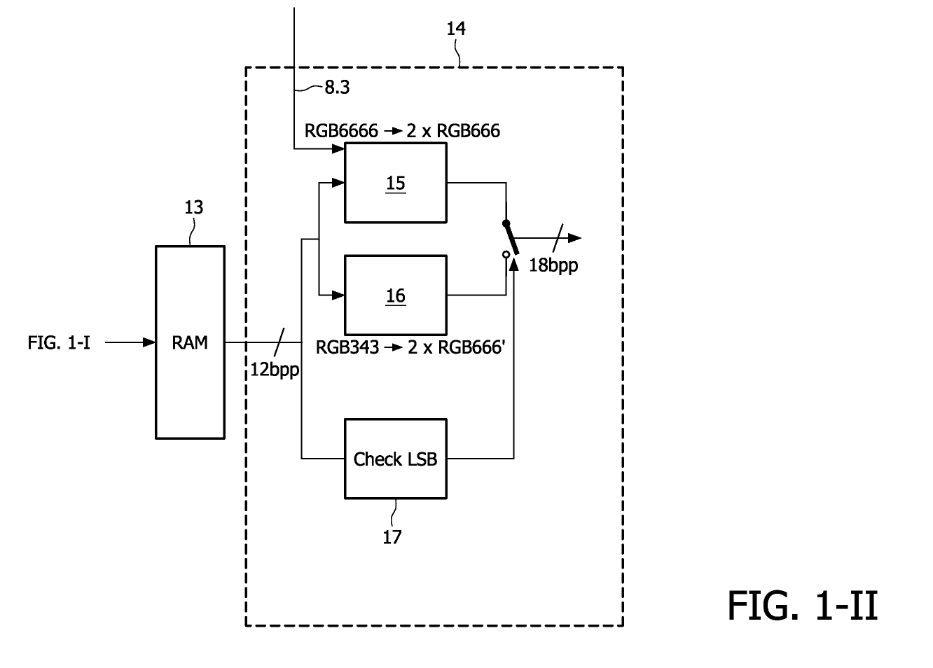

FIG. 1 shows a schematic block diagram of a first embodiment, according to the present invention, where RGB data is encoded before being stored in a frame memory and decoded after retrieval from said memory;

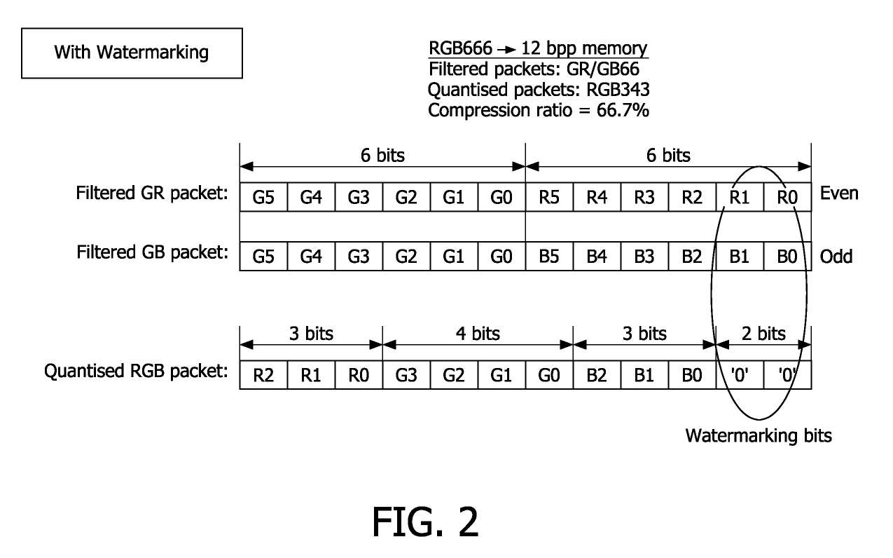

FIG. 2 shows a schematic diagram that is used to illustrated how the watermarked compression-format code can be embedded into quantized and filtered packets.

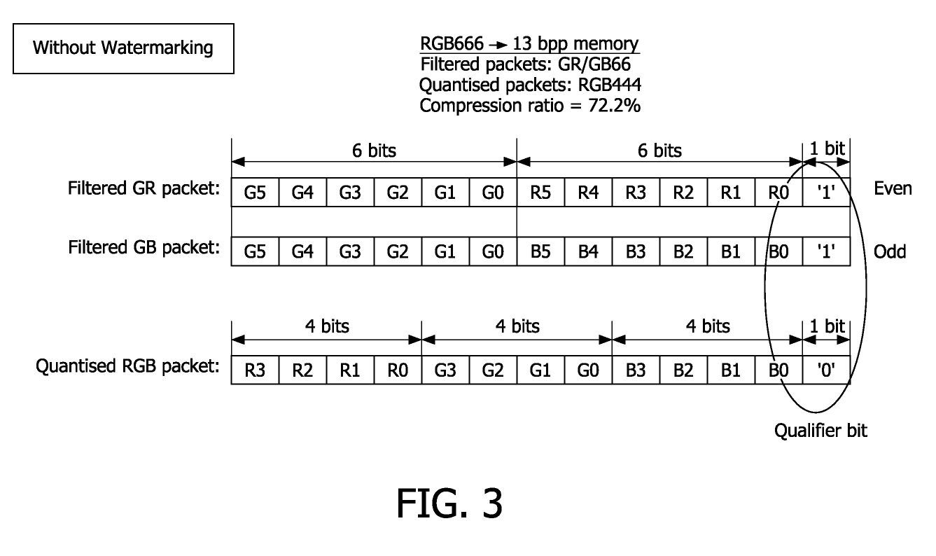

FIG. 3 shows a schematic diagram of a comparable situation without watermarking.

Before addressing detailed embodiments of the invention, some basic information about conventional conversion and compression schemes is given.

A color image, as processed by a display driver for instance, is quite often presented in an RGB format. This is a format where the pixels of a color image are composed of red (R), green (G) and blue (B) components.

The YUV format expresses the pixel properties in terms of luminance (Y) and chrominance (U, V) components. Luminance, or luma, refers to the black-and-white information in the image data and chrominance, or chroma, refers to the color information in the image data. The YUV color space differentiates between luminance and chrominance properties that now can be treated separately.

A first embodiment of the present invention is presented in FIG. 1. This embodiment is based on the invention as disclosed in the above-mentioned co-pending patent application. Details of this co-pending application—in particular the algorithms and equations relating to the compression process—are, as far as relevant in the present context, incorporated by means of reference.

The circuit 10 of FIG. 1 may be part of a display driver, for instance, and comprises a frame memory 13 (e.g., a RAM) for temporarily storing image data representing a color image. The RAM 13 may have in the present embodiment an 12 bpp internal format, for example. Other internal formats are possible as well. Please note that due to the fact that the present invention uses a watermarking approach, just 12 bpp are required. Without the watermarking, 13 bpp would have been necessary, as will be described later on.

A data bus 11.1 is provided for feeding RGB-formatted image data via an interface block 11 (I/F) and encoding block 12 to the frame memory 13. The interface block 11 is in the present example an RGB666 interface. For example 18 bpp RGB formatted image data may enter the encoding block 12 via the interface block 11. According to the present invention, there are means for performing a decision process. These means are in the present embodiment composed of the elements 8 and 9.

The decision process is based on an analysis of the color characteristics of a pixel cluster (e.g. a pixel pair) of the image data received via the bus 11.1. The means 8 and 9 for performing a decision process allow the circuit 10 to decide whether a first compression format (color compression) or a second compression format (RGB quantization) is to be applied for compression of the pixel cluster. In the present embodiment, the encoding block 12 comprises first compression means 7 performing a compression of the pixel cluster into the first compression (color compressed) format. This format is herein referred to as RGBG format. The encoding block 12 further comprises second compression means 6 performing a compression of the pixel cluster into the second (RGB quantized) format. This format is herein referred to as QRGB format. Either the first compression format or the second compression format is selected based upon the results of the decision process.

In other words, the first compression means 7 collects two adjacent pixels (original inputs R₀G₀B₀ and R₁G₁B₁), converts them to YUV, averages the U and V components and converts them back to an averaged RGBG representation (the result of which is referred to as RGB6666 in FIG. 1). The respective RGBG representation has 24 bits (holding two compressed pixels) if the RGB formatted word at the input bus 11.1 has two pixels of 18 bits. It represents the original two pixels and expresses them as 12 bits with respect to an input pixel. The initial 18 bpp representation has thus been transformed (compressed) into a 12 bpp representation (compression factor of 18/12=1.5).

At the same time, as stated above, the second compression means 6 processes the same two adjacent pixels (original inputs R₀G₀B₀ and R₁G₁B₁) in order to perform the color quantization. The respective representation has 12 bits (holding two watermarked compressed pixels) if the RGB formatted word at the input bus 11.1 has two pixels of 18 bits. In FIG. 1 the output of the second compression means 6 RGB343 has 10+2 bits.

Note that the first compression means 7 never set the LSB 0/1 to “00”. The second compression means 6, however, always set the LSB 0/1 to “00”. This is schematically illustrated in FIG. 1.

The encoder 12 will take pixel pairs or pixel clusters from the interface 11 and utilize the two different compression algorithms or schemes, as described. The first compression means 7 in the present example apply a first compression algorithm (color compression) and will produce four subpixels G₀R₀G₁B₁. In FIG. 1 this process is indicated by the expression: 2·RGB666 [symbol] RGB6666. These four subpixels G₀R₀G₁B₁ represent the YUV 4:2:2 filtered result in the RGB domain of the pixel pair R₀G₀B₀ and R₁G₁B₁. The second compression means 6 in the present example apply a second compression algorithm (RGB quantization). It will remove some LSB (least significant bits) from the pixels R₀G₀B₀ and R₁G₁B₁.

Next, the results of the two compressions which were done in parallel are compared by the decision block 9 (e.g., a decision logic) with the original inputs R₀G₀B₀ and R₁G₁B₁. For this purpose, the original inputs R₀G₀B₀ and R₁G₁B₁ are fed via a bus 11.2 to the decision block 9. According to the present invention the result closest to the original is chosen for storage in the memory 13. The decision block 9 controls the switching means 8 accordingly. This process also determines the value of the qualifier (compression-format code). The compressed data (quantized/filtered) contains an embedded code such that the decoder can recognize the packet compression format. This value in the present embodiment is either quantized (in which case the RGB quantization of the pixel pair R₀G₀B₀ and R₁G₁B₁ was performed), or filtered (in which case the color compression of the pixel pair R₀G₀B₀ and R₁G₁B₁ was performed). The filtered result contains two subpixels (R₀ and G₀) that belong to the horizontal even pixel positions and there are also two subpixels (G₁ and B₁) that belong to the horizontal odd pixel positions. The two subpixels (R₀ and G₀) for even pixel positions are provided by the sub-block 7.1 and the two subpixels (G₁ and B₁) for odd pixel positions are provided by the sub-block 7.2. When filtered subpixels are stored in the memory 13, the packet to use depends on the horizontal pixel location in the memory 13. A switch S1 being part of the switching means 8 is controlled by a signal called “odd/even pixel position”, as indicated in FIG. 1. The switching means 8 further comprise a switch S2 which is controlled by the decision block 9 to select the appropriately compressed data.

As illustrated in FIG. 1, the circuit 10 further comprises a decoder block 14. The decoder block 14 has two decoder units 15 and 16. The unit 15 processes data retrieved from the memory 13 in order to re-establish the original pixel pair R₀G₀B₀ and R₁G₁B₁. In FIG. 1 this process is indicated by the expression: RGB6666 [symbol] 2·RGB666 That is, the unit 15 performs the inverse operation of the units 7.1 and 7.2. A position control signal (driven by the memory READ process) drives a corresponding switch inside the unit 15. The unit 16 is arranged in parallel and decodes the quantized pixels in order to obtain a pixel pair R′₀G′₀B′₀ and R′₁G′₁B′₁ being almost identical to the original pixel pair. In FIG. 1 this process is indicated by the expression: RGB343 [symbol] 2·RGB666′.

There is a building block 17 being part of the decoder block 14 (or being connected to the decoder block 14), that is designed in order to control switching means 18. The building block 17 checks the LSB of the data retrieved from the memory 13. If the bits are “00” (logic zeros), then the output of the unit 16 is selected, else the output of the unit 15 is selected.

As illustrated in FIG. 1, a position control signal (driven by the memory WRITE process) is applied via a line 8.1 to the switching means 8 at the encoder side and the unit 15 at the decoder side. FIG. 1 does not show the processes that control the writing and reading to/from the memory 13. The write process knows the odd/even position that it is writing to and sends this information to the control switch S1 of block 8 such that a GR or GB packet is delivered at the output 8.2. The read process (mostly independent from the WRITE process) also knows the odd/even position that it's reading from the memory 13, since it receives the above-mentioned position control signal (driven by the memory READ process) via the line 8.3. The odd/even information is sent via the line 8.3 to the decoder 15 such that a GR or GB packet can be decoded.

Further aspects of this invention will now be addressed in connection with the FIGS. 2 and 3. FIG. 2 shows that with the inventive scheme just 12 bits per pixel are required no matter whether the RGB input data are filtered or quantized. That is, in case of filtering there must be sufficient space in the memory 13 for two subpixels in their original interface bit depth (2×6 bits). The upper two rows in FIG. 2 show the results provided at the output side of the block 7.1 or 7.2, respectively. The lower most row in FIG. 2 illustrates the result of the quantization where the input 2 times RGB666 is transformed into RGB343 and where the last two bits (the LSB 0/1) are forced to be “00”. This figure illustrates that in case of the filtering no bits are reserved for or occupied by the qualifier (compression-format code). The quantization approach employed, however, allows the two least significant bits to be set to “00”. The compression ratio is 66.7% in the present example. One just needs a 12 bpp memory 13.

Without watermarking, the qualifier (compression-format code) has to be added to the filtered packets and to the quantized packets, as shown in FIG. 3. That is, one bit is reserved exclusively for the qualifier (“0”=quantized, and “1”=filtered, for instance). In case of filtering there must be sufficient space in the memory 13 for two subpixels in their original interface bit depth (2×6 bits), whereas in case of quantization the same space will be occupied by the quantized subpixels (3×4 bits). The compression ratio is 72.2% in this case. This means that without the invention one would need a 13 bpp memory 13.

According to another embodiment of the present invention, the watermarking scheme can be implemented so that the encoder 12, respectively the second compression means 6, watermarks the qualifier by conditionally modifying the red (R) or blue (B) subpixel values. The values with bit₀=bit₁=0 are excluded by forcing bit₀ to “1” in that case. This results in a minimal distortion of the higher quality filtered pixels. Notice that the useable codes for red and blue subpixels will be reduced by 25% (2⁶=64 [symbol] 0.75×64=48 levels) because there is a statistical probability of 25% that both bits are zero. For quantized packets the same bits must be set to zero. Later on, the filtered packets can be distinguished from the quantized packets by inspecting the watermark bits. With both bits zero, a quantized packet is detected, otherwise a filtered packet is detected. As in case of the embodiment of FIG. 1, here also the two watermark bits of the quantized packets cannot contribute to the bit resolution which means that only 12-2 bits are available. Since the green is considered more important (it carries 60% of the luminance information) than red or blue, the bits may be distributed as RGB343, for instance. It is an advantage of this embodiment that for its implementation nothing more than a NOR gate is required to produce bit₀ as follows: bit₀=bit₀ NOR bit₁.

According to another embodiment of the invention more than just two compression schemes are employed. The above described embodiments where two compression algorithms are used can be expanded to more than two algorithms. Like in the above embodiments, a decision process will be employed to select the best result. In that sense, the inventive scheme is scalable.

By comparing the images that can be obtained using conventional compression schemes and the present scheme with watermarking used for embedding the qualifier, one can see that the watermarked qualifier is nicely hidden for the human viewer. This means that 1/13=7.7% of the memory 13 can be saved without sacrificing the image quality.

The scheme presented herein has the advantage that it works for lots of different image types, such as RGB/YUV movies, still pictures, scaled material, data graphics menus, etc.).

It has been demonstrated that the watermarking approach presented herein can be used to increase the savings in memory storage and to drop the overall cost for mobile display drivers, for instance.

The invention presented herein can be exploited by display drivers with embedded frame memory to store and display more colors in a memory of the same size, to reduce the memory size and thus the costs while maintaining the color resolution, or to reserve memory bits for other processing purposes (e.g. overlay/overdrive).

It is an advantage of the invention presented herein that the hardware needed to implement the watermarking is very limited. This is important for mobile applications in particular but can also be used in other areas.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable subcombination.

In the drawings and specification there has been set forth preferred embodiments of the invention and, although specific terms are used, the description thus given uses terminology in a generic and descriptive sense only and not for purposes of limitation.

1. Display driver with a frame memory for temporarily storing image data representing a color image, and a data bus for feeding image data to said display driver, characterized in that said display driver comprises:
means for performing a decision process, said decision process being based on an analysis of the color characteristics of a pixel cluster of said image data, the means for performing a decision process allowing the display driver to decide whether a first compression format or a second compression format is to be applied for compression of said pixel cluster,
first compression means performing a compression of said pixel cluster into said first compression format,
second compression means performing a compression of said pixel cluster into said second format,
wherein said first compression format or said second compression format is selected based upon said results of said decision process, and compressed pixel clusters are stored after compression in an available storage area of said frame memory, and a compression-format code is stored indicating which compression format was used for which pixel cluster, said compression-format code being embedded into the compressed pixel clusters as a watermark.

2. The display driver of claim 1, wherein said first compression format is an RGBG color compressed format and said second compression format is an RGB quantized (QRGB) format.

3. The display driver of claim 2, wherein said second compression means always set the least significant bits 0/1 to “00”, said least significant bits being used as compression-format code for RGB quantized (QRGB) compressed pixel clusters.

4. The display driver of claim 2, wherein said second compression means always set the least significant bits 0/1 to “00”, said least significant bits serving as embedded compression-format code.

5. The display driver of claim 1, comprising an input for receiving a position control signal that subpixels that belong to horizontal even pixel positions and subpixels that belong to horizontal odd pixel positions to be selected.

6. The display driver of claim 5, further comprising a first switch being controllable by said position control signal.

7. The display driver of claim 5, further comprising a second switch being controllable by an output signal of the means for performing a decision process.

8. The display driver of claim 3, further comprising a building block for checking the least significant bits 0/1 the data retrieved from the frame memory.

9. The display driver of claim 8, comprising:
first decompression means performing a decompression into a cluster of RGB format based pixels of those pixel clusters that were compressed using said first compression format,
second decompression means performing a decompression into a cluster of RGB format based pixels of those pixel clusters that were compressed using said second compression format,
wherein said first decompression means and second decompression means take into consideration said embedded compression-format code.

10. The display driver of claim 9, wherein said building block selects data output by said second decompression means if the least significant bits 0/1 are “00”, and data output by said first decompression means if the least significant bits 0/1 are not “00”.

11. The display driver of claim 1, wherein the frame memory is an embedded frame memory.

12. Method for color compression and decompression of RGB-formatted image data comprising the following steps:
collecting n adjacent input pixels,
performing a color compressing of said n adjacent input pixels to generate a color compressed representation of these n adjacent input pixels,
at the same time performing a quantization compression of said n adjacent input pixels to generate a quantized representation of these n adjacent input pixels,
comparing the quantized representation and the color compressed representation with said n adjacent input pixels in order to determine whether the color compression or the quantization compression leads to a smaller error than the respective other,
storing either the color compressed representation in a frame memory if the error of the color compression is smaller than the error of quantization compression, or storing the quantization compressed representation in a frame memory if the error of the quantization compression is smaller than the error of the color compression,
embedding a watermarked compression-format code into said quantized representation before storing said quantized representation in said frame memory.

13. The method of claim 12, wherein said embedding of a watermarked is done by setting the least significant bits 0/1 to “00”, said least significant bits being used as the compression-format code for RGB quantized (QRGB) compressed pixel clusters.

14. The method of claim 12, wherein said embedding of a watermarked is done by always setting the least significant bits 0/1 to “00”, said least significant bits serving as embedded compression-format code.

15. The method of claim 12, comprising the step receiving a control signal via an input for selecting subpixels belonging to horizontal even pixel positions and subpixels belonging to horizontal odd pixel positions.

16. The method of claim 12, comprising the steps:
retrieving data from the frame memory, and
checking the least significant bits 0/1 of the data retrieved from the frame memory to determine the appropriate decoding scheme.

17. The method of claim 12 being implemented in the front end of a display driver.
